(19) United States
(12) Patent Application Publication
(10) Pub. No.: US 2020/0167896 A1
(43) Pub. Date: May 28, 2020

(54) IMAGE PROCESSING METHOD AND DEVICE, DISPLAY DEVICE AND VIRTUAL REALITY DISPLAY SYSTEM

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Wenyu LI, Beijing (CN); Yukun SUN, Beijing (CN); Jinghua MIAO, Beijing (CN); Xuefeng WANG, Beijing (CN); Jinbao PENG, Beijing (CN); Zhifu LI, Beijing (CN); Bin ZHAO, Beijing (CN); Xi LI, Beijing (CN); Qingwen FAN, Beijing (CN); Jianwen SUO, Beijing (CN); Yali LIU, Beijing (CN); Lili CHEN, Beijing (CN); Hao ZHANG, Beijing (CN)

(21) Appl. No.: 16/514,056

(22) Filed: Jul. 17, 2019

(30) Foreign Application Priority Data
Nov. 23, 2018 (CN) 201811406796.5

(51) Int. Cl. G06T 3/40; G06F 3/01; G09G 5/377

(52) U.S. Cl. CPC G06T 3/4038; G06F 3/013; G09G 5/377; G09G 2320/0252; G09G 2350/00; G09G 2340/0407; G09G 2354/00

(57) ABSTRACT

This disclosure relates to an image processing method and device, a display device, and a virtual reality display system. The image processing method includes: rendering a first image from a gaze region of a user and a second image from other regions in different frames respectively, to obtain a first image frame and a second image frame accordingly, wherein the first image frame has a resolution higher than that of the second image frame; and transmitting one of the first image frame and the second image frame.

### CROSS-REFERENCE TO RELATED APPLICATIONS

This application is based on and claims the benefit of priority to the Chinese Patent Application No. 201811406796.5, filed on Nov. 23, 2018, which is hereby incorporated by reference in its entirety into the present application.

### TECHNICAL FIELD

This disclosure relates to the display field, and particularly to an image processing method and device, a display device, a virtual reality display system and a computer readable storage medium.

### BACKGROUND

With the rapid development of the display technology, demands for display quality is getting higher and higher. On the one hand, high resolution is required, and on the other hand, high refresh frame rate is required, which raises great demands for the image processing technology.

### SUMMARY

According to a first aspect of the embodiments of this disclosure, an image processing method is provided, comprising: rendering a first image from a gaze region of a user and a second image from an other region in different frames respectively, to obtain a first image frame and a second image frame accordingly, wherein the first image frame has a resolution higher than that of the second image frame; and transmitting one of the first image frame and the second image frame.

In some embodiments, one second image frame is transmitted per transmission of N image frames, where N is a positive integer greater than 1.

In some embodiments, the image processing method further comprises: determining whether the first image or the second image is rendered in current frame.

In some embodiments, let the current frame be Mth frame, where M is a positive integer: render the second image if M/N is an integer, and render the first image if M/N is not an integer.

In some embodiments, the image processing method further comprises: receiving and storing the transmitted first image frame and second image frame; and combining the stored first image frame and second image frame into a complete image.

In some embodiments, the combining comprises: stitching adjacent first image frame and second image frame.

In some embodiments, stitching adjacent first image frame and second image frame comprises: obtaining a position of the first image frame on a display screen from gaze point coordinates of the user, which are obtained from an image of the user's eyeball; and stitching adjacent first image frame and second image frame according to the position of the first image frame on the display screen.

In some embodiments, the image processing method further comprises before the stitching: boundary-fusing the adjacent first image frame and second image frame, and stretching the second image frame.

In some embodiments, boundary-fusing is performed using a weighted average algorithm; and stretching is performed by means of interpolation.

In some embodiments, N is less than 6.

In some embodiments, the image processing method further comprises: obtaining gaze point coordinates of the user from an image of the user's eyeball; and acquiring the gaze region of the user using an eyeball tracking technology.

In some embodiments, the image processing method further comprises: performing image algorithm processing on at least one of the rendered first image frame or second image frame.

In some embodiments, the image processing method further comprises: performing image algorithm processing on at least one of the rendered first image frame or second image frame.

In some embodiments, the image algorithm comprises at least one of anti-distortion algorithm, local dimming algorithm, image enhancement algorithm, or image fusing algorithm.

In some embodiments, the other region comprises a region other than the gaze region of the user or a whole region with the gaze region of the used included.

According to a second aspect of the embodiments of this disclosure, an image processing device is provided, comprising: a memory configured to storing computer instructions; and a processor coupled to the memory, wherein the processor is configured to perform one or more steps of the image processing method according to any of the preceding embodiments, based on the computer instructions stored in the memory.

According to a third aspect of the embodiments of this disclosure, a non-volatile computer-readable storage medium is provided, with a computer program stored thereon, which implements one or more steps of the image processing method according to any of the preceding embodiments when executed by a processor.

According to a fourth aspect of the embodiments of this disclosure, a display device is provided, comprising the image processing device according to any of the preceding embodiments. In some embodiments, the display device further comprises: an image combining processor configured to combining the first image frame and the second image frame to obtain a complete image; and a display configured to display the complete image.

In some embodiments, the display device further comprises an image sensor configured to capture an image of the user's eyeball, from which the gaze region of the user is determined.

According to a fifth aspect of the embodiments of this disclosure, a virtual reality display system is provided, comprising the display device according to any of the preceding embodiments.

The other features of this disclosure and their advantages will become clear through a detailed description of the exemplary embodiments of this disclosure with reference to the accompanying drawings below.

### BRIEF DESCRIPTION OF THE DRAWINGS

The accompanying drawings which constitute a part of the specification describe the embodiments of this disclosure, and together with the description, serve to explain the principle of this disclosure.

This disclosure can be understood more clearly with reference to the accompanying drawings according to the following detailed description, in which:

FIG. 1 is a flowchart showing an image processing method according to an embodiment of this disclosure;

FIG. 2 is a flowchart showing an image processing method according to another embodiment of this disclosure;

FIG. 3A is a schematic diagram showing an image processing method in a comparative example;

FIG. 3B is a schematic diagram showing an image processing method according to an embodiment of this disclosure;

FIG. 4 is diagram showing a comparison in effect between the image processing method according to an embodiment of this disclosure and the image processing method in the comparative example;

FIG. 5A is a block diagram showing an image processing device according to an embodiment of this disclosure;

FIG. 5B is a block diagram showing an image processing device according to another embodiment of this disclosure;

FIG. 6 is a block diagram showing a display device according to an embodiment of this disclosure;

FIG. 7 is a block diagram showing a computer system for implementing an embodiment of this disclosure.

It should be noted that, the dimensions of the parts shown in the accompanying drawings are not drawn in accordance with actual proportional relationships. In addition, identical or similar reference numerals represent identical or similar composite parts.

### DETAILED DESCRIPTION

The various exemplary embodiments of this disclosure are now described in detail with reference to the accompanying drawings. The description of the exemplary embodiment is merely illustrative and by no means serves as any restriction to this disclosure and its application or use. This disclosure can be implemented in many different forms and is not limited to the embodiments described here. These embodiments are provided in order to make this disclosure thorough and complete, and to fully express the scope of this disclosure to a person skilled in the art. It should be noted that, unless otherwise specified, the relative arrangements of the components and steps described in these embodiments should be interpreted as merely illustrative but not restrictive.

All terms (including technical terms or scientific terms) that are used in this disclosure have the same meanings as those understood by a person of ordinary skill in the field to which this disclosure pertains, unless otherwise specifically defined. It should also be understood that, terms defined in common dictionaries should be interpreted as having meanings consistent with their meanings in the context of the related technologies, rather than being interpreted in an idealized or extremely formalized sense, unless expressly defined here.

The technologies, methods and apparatuses known to those skilled in the related fields may not be discussed in detail, but where appropriate, the techniques, methods and apparatuses should be considered as part of the specification.

It is hard for related image processing technologies to meet the requirements for both high resolution and high refresh frame rate. For this reason, this disclosure proposes a solution that can achieve both high resolution and high refresh frame rate.

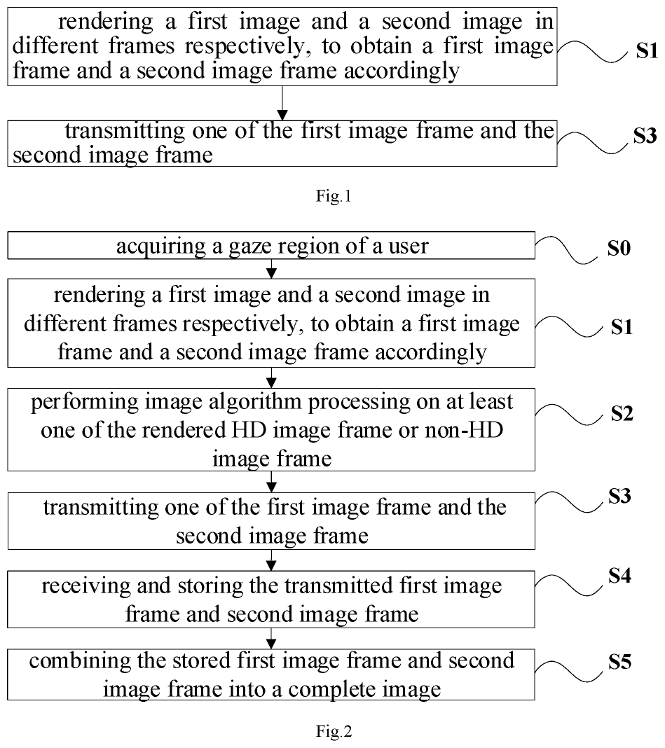

FIG. 1 is a block diagram showing an image processing method according to an embodiment of this disclosure. As shown in FIG. 1, the image processing method comprises steps S1 and S3.

In the step S1, the first image and the second image are rendered in different frames respectively, to obtain a first image frame and a second image frame accordingly.

The first image comes from a gaze region of the user, and the second image comes from an other region. The other region may be a region other than the gaze region of the user or a whole region with the gaze region of the user included. In some embodiments, in the Kth frame, an image (i.e., first image) in the gaze region of the user is rendered at a high resolution, to obtain a first image frame, where K is a positive integer. In the Lth frame, an image (i.e., second image) in the other region is rendered at a low resolution to obtain a second image frame, where L is a positive integer different from K. Accordingly, the first image frame has a resolution (i.e., a first resolution) higher than that of the second image frame (i.e., a second resolution). The rendering may be performed with an image processor. For example, the ratio between the number of unit pixels per unit area corresponding to the first resolution and that corresponding to the second resolution is in a range from 1/4 to 1/3.

In the step S3, one of the first image frame and the second image frame is transmitted.

In some embodiments, one second image frame is transmitted per transmission of N image frames, where N is a positive integer greater than 1. For the sake of description below, the first image frame with a high resolution is called high definition (HD) image frame, and the second image frame with a low resolution is called non-high definition (non-HD) image frame.

By taking N=2 as an example, one non-HD image frame is transmitted per transmission of two image frames. In other words, if the HD image frame is transmitted in an odd frame, the non-HD image frame is transmitted in an even frame. Still take N=2 as an example, one image frame is transmitted once the image frame is rendered. In other words, if the non-HD image is rendered in an odd frame, the HD image is rendered in an even frame; accordingly, the non-HD image frame is transmitted in an odd frame, and the HD image frame is transmitted in an even frame.

The HD image frame and the non-HD image frame are combined into a complete image before being displayed. N can take different positive integers according to the actual needs, as long as human eyes will not feel obvious content dislocation for the complete image obtained by the combination. For example, N can also be 3, 4, or 5.

In the above embodiments, by rendering high definition image and non-high definition image in different frames respectively, and transmitting the high definition image and non-high definition image in different image frame, rendering pressure and image transmission bandwidth can be significantly reduced, thereby increasing the refresh frame rate while ensuring high resolution.

In some embodiments, the image processing method further comprises: determining whether a HD image or a non-HD image is rendered in current frame. Let the current frame be Mth frame, where M is a positive integer, which image is rendered and transmitted can be determined based on a relationship between M and N. For example, a non-HD image is rendered and transmitted if M/N is an integer, and a HD image is rendered and transmitted if M/N is not an integer.

Take N=5 as an example, i.e., one frame of non-HD image and four frames of HD image are rendered per five frames of image. If M=4, M/N=4/5, i.e., M/N is not an integer, a HD image is rendered and transmitted. If M=5, M/N=5/5, i.e., M/N is an integer, a non-HD image is rendered and transmitted.

In some embodiments, images are transmitted through a DisplayPort interface. In some other embodiments, images are transmitted through a HDMI (high Definition Multimedia Interface).

FIG. 2 is a flowchart showing an image processing method according to some other embodiments of this disclosure. FIG. 2 differs from FIG. 1 in that steps S0, S2, and S4-S5 are further comprised. The following will describe only the differences between FIG. 2 and FIG. 1, and the similarities therebetween are not repeated.

In the step S0, the gaze region of the user is acquired, for example, the gaze region of the user is acquired using the eyeball tracking technology.

In some embodiments, the image of the user's eyeball is captured with an image sensor such as camera, and the image of the eyeball is analyzed to obtain the gaze position (i.e., gaze point coordinates), thereby acquiring the gaze region of the user.

In step S2, image algorithm processing is performed on at least one of the rendered HD image frame or non-HD image frame.

In some embodiments, the image algorithm comprises an anti-distortion algorithm. Since the image will be distorted through a lens, in order to make the human eyes see a normal image through the lens, an opposite mapping corresponding to the distortion can be performed on normal image using the anti-distortion algorithm, to obtain an anti-distortion image, and after the anti-distortion image is distorted through the lens, the human eyes can see the normal image through the lens.

In some other embodiments, the image algorithm comprises a local dimming algorithm. Taking the liquid crystal display as an example, the display area can be divided into multiple partitions, and backlight of each partition can be controlled separately in real time using the local dimming algorithm. As a result, backlight of each partition can be controlled based on the image content corresponding to each partition, thereby improving the display contrast.

It should be understood that, the image algorithm can also include an image processing algorithm such as image enhancement algorithm. In some embodiments, both the rendered HD image frame and the rendered non-HD image frame are processed with the image algorithm. In this way, a better display effect is attained for the complete image obtained by combining the two kinds of image frames.

In the step S4, the transmitted HD image frame and non-HD image frame are received and stored.

In some embodiments, the transmitted image frames are stored with a storage device such as a memory card, so as to realize combination of the HD image frames and non-HD image frames received in different frames, for example, combination of the currently received HD image frames and the previously stored non-HD image frames.

In the step S5, the stored HD image frame and non-HD image frame are combined into a complete image.

In some embodiments, the combining comprises: stitching adjacent HD image frame and non-HD image frame. For example, first the position of the HD image frame on the display screen is obtained from the gaze point coordinates, and then on this basis, the high-definition image frame and non-HD image frame are stitched.

Still take N=5 as an example, in the case of M=5, that is, in the fifth frame, the non-HD image frame in the fifth frame and the HD image frame in the fourth frame that has been stored can be stitched to obtain a complete image. Similarly, HD images are rendered and transmitted in the sixth, seventh, eighth, and ninth frames. In this case, the HD image frames in the sixth, seventh, eighth, and ninth frames can be stitched respectively with the non-HD image frame (i.e., the fifth frame) in the stored previous frame to obtain a complete image.

In some other embodiments, the image processing method further comprises before stitching: boundary-fusing adjacent HD image frame and non-HD image frame.

Boundary fusion can ensure that other regions seen out of the corner of the human eye are a natural extension of the gaze region, in order to avoid mismatch phenomena such as content dislocation felt from the corner of the eye. For example, the boundaries of HD region and non-HD region can be fused such that the boundary of the stitched complete image has a smooth transition. According to the actual needs, different algorithms can be adopted to realize boundary fusion. For example, in the case of a smaller N, a simpler weighted average algorithm can be adopted, which can meet the requirement of content match at a low computational cost.

It should be understood that, the boundary-fusion can be performed after image transmission or before image transmission as long as before the stitching. It is required to store current image frame if the boundary-fusion is performed during the image algorithm processing.

In some further embodiments the image processing method further comprises before stitching: stretching the non-HD image frame. For example, before stitching into a complete image, the non-HD image frame can be stretched into a high-resolution image frame.

After stretching the low-resolution non-HD image frame, it can be displayed on a high-resolution screen. As an example, for a non-HD image frame with a resolution of 1080*1080, it can be stretched into a HD image frame with a resolution of 2160*2160 by means of interpolation and the like, so that it can be displayed on a screen with a resolution of 2160*2160.

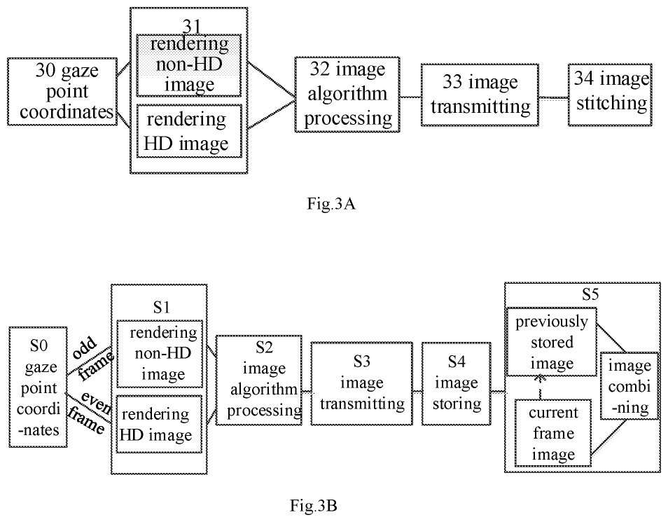

By taking a single eye as an example, the image processing method in the related technology and the image processing method according to the embodiment of this disclosure are compared in combination with FIG. 3 A and FIG. 3 B. FIG. 3 A is a schematic diagram showing the image processing method in a comparative example. FIG. 3B is a schematic diagram showing the image processing method according to some embodiments of this disclosure.

As shown in FIG. 3A, the image processing method in the comparative example comprises: a step 30 of obtaining gaze point coordinates according to the eyeball tracking technology; a step 31 of rendering the HD image in the gaze region and non-HD images in other regions; a step 32 of processing the HD and non-HD images with an image algorithm; a step 33 of transmitting the processed HD and non-HD images; and a step 34 of stitching the HD and non-HD images so as to display a complete image.

As shown in FIG. 3 B, the image processing method according to an embodiment of this disclosure comprises: a step S0 of acquiring a gaze region of a user; a step S1 of rendering a first image and a second image in different frames respectively, to obtain a first image frame and a second image frame accordingly; by taking the case where N=2 and the non-HD image is rendered first as an example, rendering the non-HD images in odd frames and rendering the high-definition images in even frames; a step S2 of performing image algorithm processing on the rendered image frames; a step S3 of transmitting one of the HD image frame and the non-HD image frame; a step S4 of receiving and storing the transmitted image frames; and a step S5 of combining the HD image frame and the non-HD image frame into a complete image for display.

For step S1, the parity of a frame may be determined from whether frame number is divisible by 2. For example, let current frame is Mth frame, the parity of the Mth frame is determined from whether M is divisible by 2. For step S2, the image of current frame may be stored before the image algorithm processing.

As can be learned from the comparison between FIG. 3A and FIG. 3B, in the image processing method in the comparative example, two images are rendered in one frame of time, and it needs to transmit two images for a single eye; while in the image processing method according to the embodiments of this disclosure, only one image is rendered in one frame of time, and it needs to transmit one image for a single eye. Therefore, the use of the image processing method according to the embodiment of this disclosure can significantly reduce the rendering pressure and image transmission bandwidth, thereby increasing the refresh frame rate while ensuring high resolution.

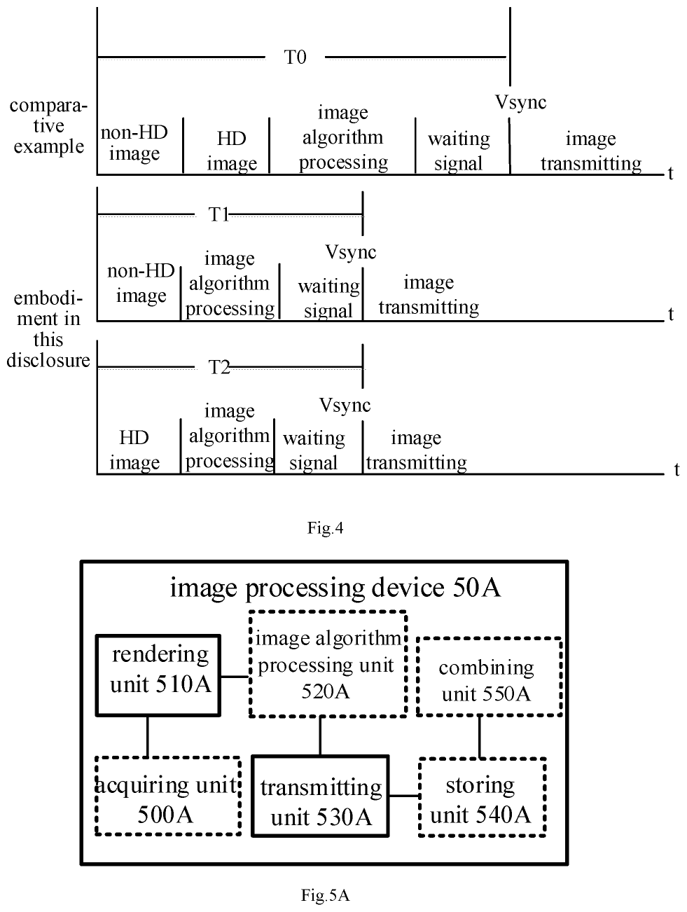

FIG. 4 is a diagram showing a comparison in effect between the image processing method according to some embodiments of this disclosure and the image processing method in the comparative example.

FIG. 4 shows timing diagrams of different image processing methods. FIG. 4 is described in case where the processing of one frame includes a rendering stage, an image processing stage and a signal waiting stage. That is, one frame of time discussed in FIG. 4 is a period between adjacent synchronous signals Vsync, which mainly includes the rendering time and the image algorithm processing time, but does not include the image transmitting time and the stitching time. Assuming that an image is rendered in the Kth frame, when the Vsync signal arrives, the rendered image will be transmitted to the combining stage, and at the same time it is started to render another image in the (K+1)th frame. After the images are received in the combining stage, combining processing such as stitching is performed for final display.

In some embodiments, the stages before the image transmission, such as rendering and image algorithm processing, can be implemented by software, and the stages after the image transmission, such as combining and display, can be implemented by hardware. One frame of time corresponding to two different stages can be equal and can be in parallel.

As shown in FIG. 4, by use of the image processing method in the comparative example, in either the rendering or the image algorithm processing, for a single eye, it needs to process two images, i.e., HD image and non-HD image, in one frame of time, and the time spent is T0. In contrast, by use of the image processing method according to the embodiment of this disclosure, for a single eye, only one image is rendered in one frame of time, and the image algorithm also processes only one image, and the time spent is T1 or T2. Analyzed from the principle and learned from the visual display in the timing diagram, T0 is far greater than T1. Since T1 and T2 are generally nearly equal, T0 is nearly twice T1.

Further, by use of the image processing method according to the embodiment of this disclosure, for a single eye, only one image is transmitted per frame, that is, as compared with the comparative example, the transmission speed is improved, and the restriction of the transmission bandwidth with respect to the frame rate is avoided.

To sum up, the image processing method according to the embodiment of this disclosure not only reduces the rendering pressure, but also avoids the restriction of the transmission bandwidth, and greatly increases the display refresh frame rate while ensuring high resolution.

FIG. 5A is a schematic diagram showing a structure of an image processing device according to some embodiments of this disclosure. As shown in FIG. 5A, the image processing device 50A comprises: a rendering unit 510A and a transmitting unit 530A.

The rendering unit 510A is configured to render a first image and a second image in different frames respectively, to obtain a first image frame and a second image frame accordingly, for example, it can perform the step S1 as shown in FIG. 1 or FIG. 2. As mentioned above, the first image comes from the gaze region of the user, and the second image comes from the other region. Since the first image is rendered at a high resolution and the second image is rendered at a low resolution, accordingly, the first image frame has a resolution higher than that of the second image frame.

The transmitting unit 530A is configured to transmit one of the first image frame and the second image frame, for example, it can perform the step S3 as shown in FIG. 1 or FIG. 2. As mentioned above, transmitting herein may represent the transmission of one second image frame per transmission of N image frames.

In some embodiments, the image processing device 50A further comprises: an acquiring unit 500A configured to acquire the gaze region of the user using the eyeball tracking technology, for example, it can perform the step S0 shown in FIG. 2.

The image processing device 50A can further comprise: an image algorithm processing unit 520A configured to perform image algorithm processing on at least one of the rendered first image frame and second image frame, for example, it can perform the step S2 shown in FIG. 2.

In some other embodiments, the image processing device 50A further comprises: a storing unit 540A configured to store the received image frames, for example, it can perform the step S4 shown in FIG. 2. As mentioned above, the received image frames can be stored with a memory card or the like, so as to realize frame combination of the HD image frame and non-HD image frame received in different frames.

In some other embodiments, the image processing device further comprises: a combining unit 550A configured to combine the received first image frame and second image frame into a complete image, for example, it can perform the step S5 shown in FIG. 2. As mentioned above, the combining may comprise stitching adjacent first image frame and second image frame. The combining may further include stretching the second image frame. The combining may also comprise boundary fusing the adjacent first image frame and second image frame, such that the boundary of the stitched complete image has a smooth transition.

FIG. 5B is a block diagram showing an image processing device according to some other embodiments of this disclosure.

As shown in FIG. 5B, the image processing device 50B comprises: a memory 510B and a processor 520B coupled to the memory 510B. The memory 520B is configured to store instructions that perform corresponding embodiments of the image processing method. The processor 520B is configured to perform the image processing method according to any of some embodiments in this disclosure based on the instructions stored in the memory 520B.

It should be understood that each of the steps in the image processing method can be implemented through a processor and can be implemented by means of any of software, hardware, firmware, or a combination thereof.

In addition to the image processing method and device, the embodiments of this disclosure may also take the form of a computer program product implemented on one or more non-volatile storage media containing computer program instructions. Therefore, the embodiments of this disclosure further provide a computer-readable storage medium on which computer instructions are stored, when executed by the processor, implement the image processing method according to any of the preceding embodiments.

The embodiments of this disclosure further provide a display device, comprising the image processing device described in any of the preceding embodiments.

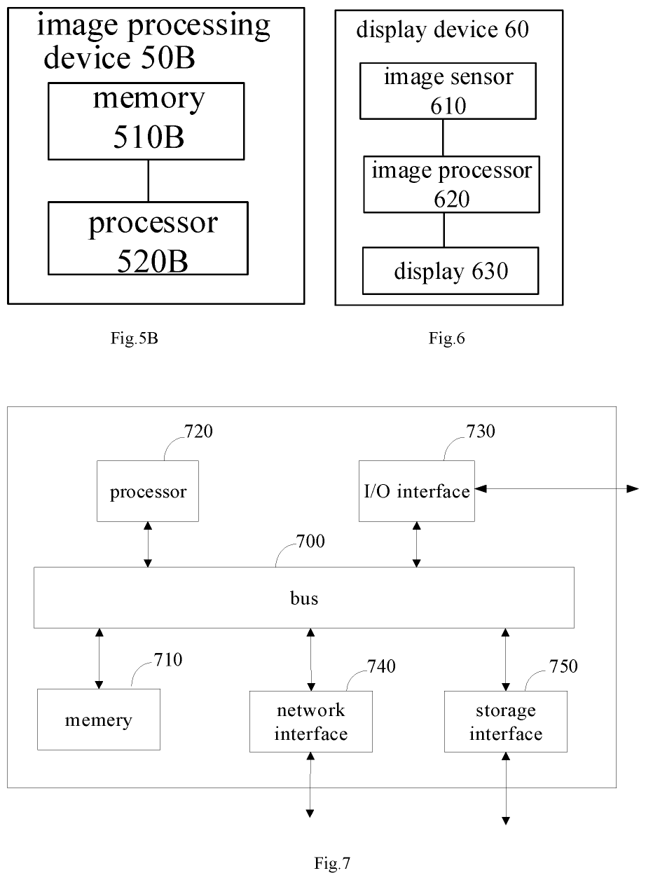

FIG. 6 is a block diagram showing a display device according to some embodiments of this disclosure. As shown in FIG. 6, the display device 60 comprises an image sensor 610, an image processor 120, and a display 630.

The image sensor 610 is configured to capture an image of the user's eyeball. By analyzing the image of the eyeball, the gaze position can be obtained, thereby acquiring the gaze region of the user. In some embodiments, the image sensor includes a camera.

The image processor 620 is configured to perform the image processing method described in any of the preceding embodiments. That is, the image processor 620 can perform some of the steps S0 through S5, such as steps S1 and S3.

The display 630 is configured to display the complete image obtained by combining the first image frame and the second image frame. In some embodiments, the display includes a liquid crystal display. In some other embodiments, the display includes an OLED (Organic Light-Emitting Diode) display.

In some embodiments, the display devices can be: mobile phones, tablet computers, televisions, laptop computers, digital photo frames, navigators and any other product or component with the display function.

The embodiments of this disclosure further provide a virtual reality (VR) display system comprising the display device described in any of the preceding embodiments. An ultra-high resolution SmartView-VR system can be provided using the display device according to the embodiment of this disclosure.

FIG. 7 is a block diagram showing a computer system for implementing some embodiments of this disclosure.

As shown in FIG. 7, the computer system can behave in the form of a general computing device. The computer system includes a memory 710, a processor 720, and a bus 700 that connects different system components.

The memory 710 can include, for example, system memory, non-volatile storage media, and so on. The system memory, for example, is stored with operating systems, applications, boot loaders, and other programs. The system memory can include volatile storage medium, such as random access memory (RAM) and/or cache memory. The non-volatile storage medium, for example, stores instructions of corresponding embodiments that perform the display method. The non-volatile storage medium includes, but is not limited to, disk memory, optical memory, flash memory, and so on.

The processor 720 can be implemented using universal processors, digital signal processors (DSPS), application-specific integrated circuits (ASIC), field programmable gate arrays (FPGAS), or other programmable logic devices, discrete hardware components such as discrete gates or transistors. Accordingly, each module such as judging module and determining module, can be implemented through the instructions of performing the corresponding steps in the memory by the Central Processing Unit (CPU), or through dedicated circuits that perform the corresponding steps.

The bus 700 can adopt any bus structure in a variety of bus structures. For example, the bus structure includes, but is not limited to, the Industrial Standard Architecture (ISA) bus, the Microchannel Architecture (MCA) bus, and the Peripheral Component Interconnect (PCI) bus.

The computer system can also include an input and output interface 730, a network interface 740, a storage interface 750 and so on. These interfaces 730, 740, 750, and the memory 710 and the processor 720 can be connected with each other via the bus 700. The input and output interface 730 can provide a connection interface for an input and output device such as display, mouse, keyboard. The network Interface 740 provides a connection interface for various networked devices. The storage interface 750 provides a connection interface for external storage devices such as floppy disks, USB drives, and SD cards.

So far, the various embodiments of this disclosure have been described in detail. In order to avoid shielding the idea of this disclosure, some of the details well known in the art are not described. Those skilled in the art can fully understand how to carry out the technical solutions disclosed herein according to the above description.

Although some specific embodiments of this disclosure have been described in detail by way of examples, those skilled in the art should understand that the above examples are for illustrative purposes only, but not for limiting the scope of this disclosure. Those skilled in the art should understand that the above embodiments can be modified or some technical features can be equivalently replaced without departing from the scope and spirit of this disclosure. The scope of this disclosure is limited by the attached claims.

What is claimed is:

1. An image processing method, comprising:
rendering a first image from a gaze region of a user and a second image from another region in different frames respectively, to obtain a first image frame and a second image frame accordingly, wherein the first image frame has a resolution higher than that of the second image frame; and
transmitting one of the first image frame and the second image frame.

2. The image processing method according to claim 1, wherein one second image frame is transmitted per transmission of N image frames, where N is a positive integer greater than 1.

3. The image processing method according to claim 2, further comprising: determining whether the first image or the second image is rendered in a current frame.

4. The image processing method according to claim 3, wherein the current frame is an Mth frame, where M is a positive integer:
render the second image if M/N is an integer, and
render the first image if M/N is not an integer.

5. The image processing method according to claim 2, further comprising:
receiving and storing the transmitted first image frame and second image frame; and
combining the stored first image frame and second image frame into a complete image.

6. The image processing method according to claim 5, wherein the combining comprises:
stitching the adjacent first image frame and second image frame.

7. The image processing method according to claim 6, wherein stitching the adjacent first image frame and second image frame comprises:
obtaining a position of the first image frame on a display screen from gaze point coordinates of the user, which are obtained from an image of an eyeball of the user; and
stitching adjacent first image frame and second image frame according to the position of the first image frame on the display screen.

8. The image processing method according to claim 6, further comprising before the stitching:
boundary-fusing the adjacent first image frame and second image frame; and
stretching the second image frame.

9. The image processing method according to claim 8, wherein:
boundary-fusing is performed using a weighted average algorithm; and
stretching is performed by means of interpolation.

10. The image processing method according to claim 2, wherein N is less than 6.

11. The image processing method according to claim 1, further comprising:
obtaining gaze point coordinates of the user from an image of an eyeball of the user; and
acquiring the gaze region of the user according to the gaze point coordinates of the user.

12. The image processing method according to claim 1, further comprising:
performing image algorithm processing on at least one of the rendered first image frame or second image frame.

13. The image processing method according to claim 12, wherein the image algorithm processing comprises at least one of anti-distortion algorithm, local dimming algorithm, image enhancement algorithm, or image fusing algorithm.

14. The image processing method according to claim 1, wherein the other region comprises a region other than the gaze region of the user or a whole region with the gaze region of the used included.

15. An image processing device, comprising:
a memory configured to store computer instructions; and
a processor coupled to the memory, wherein the processor is configured to perform the image processing method according to claim 1, based on the computer instructions stored in the memory.

16. A non-volatile computer-readable storage medium with a computer program stored thereon, which implements the image processing method according to claim 1 when executed by a processor.

17. A display device, comprising the image processing device according to claim 15.

18. The display device according to claim 17, comprising:
an image combining processor configured to combining the first image frame and the second image frame to obtain a complete image; and
a display configured to display the complete image.

19. The display device according to claim 17, further comprising:
an image sensor configured to capture an image of an eyeball of the user, from which the gaze region of the user is determined.

20. A virtual reality display system, comprising the display device according to claim 17.
